(19) United States
(12) Patent Application Publication
(10) Pub. No.: US 2024/0005229 A1
(43) Pub. Date: Jan. 4, 2024

(54) Immigration Program Qualification Assessment System and Method of Use

(71) Applicant: OUR CANADA SERVICES INC., Vancouver (CA)

(72) Inventors: Muhammad Ubaid Afzal, Vancouver (CA); Maryum Akhter, Vancouver (CA); Haider Mustafa, Vancouver (CA); Shawna Nadine Hubscher, Vancouver (CA)

(21) Appl. No.: 18/253,736

(22) PCT Filed: Nov. 22, 2021
(86) PCT No.: PCT/CA2021/051653

§ 371 Date: May 19, 2023

Related U.S. Application Data
(60) Provisional application No. 63/117,210, filed on Nov. 23, 2020.

(51) Int. Cl. G06Q 10/1053; G06Q 50/26

(52) U.S. Cl. CPC G06Q 10/1053; G06Q 50/26

(57) ABSTRACT

An immigration program qualification assessment system prompts the user through a computer display with a queue of the qualifying questions and receives user responses from the user through a computer input device in response to the qualifying questions. The computer system uses the user responses to assess for each program if all of the qualifying criteria for the program has been met and communicates to the user that the applicant has qualified for one of the programs if all of the qualifying criteria for that program has been met. The user responses to one or more of the qualifying questions is used by the computer system in assessing the qualifying criteria associated with more than one program.

### FIELD OF THE INVENTION

The present invention relates to a computer implement system and the method of use of that system for assessing if an applicant meets the qualifying criteria for any one of a plurality of government immigration programs, and more particularly the present invention relates to a system and method of use for prompting a user for responses and comparing the user responses to the qualifying criteria of the programs.

### BACKGROUND

The current state of the art to assess qualifications for immigrant programs is the use of separate assessment tools on the internet, each being limited for use with a single immigration program.

### SUMMARY OF THE INVENTION

The present invention uniquely assesses a user for multiple immigration programs, even when the immigration programs have different qualifying criteria that must be entered in unique formats. It doesn't simply list points for each program (although it does calculate them). It also provides qualitative information based on what score is required for selection and a value decision of whether the user or spouse exceeds that threshold. In other words, it tells a user whether or not they appear to qualify for one or more immigration programs based on generic information entered that can be converted to usable input for different immigration programs.

According to one aspect of the invention there is provided an immigration program qualification assessment system for assessing qualification of an applicant for a plurality of government immigration programs each having respective qualifying criteria associated therewith, the system comprising:
a computer apparatus comprising a processor, a memory storing programming instructions thereon and storing one or more qualifying questions associated with each of the qualifying criteria of the programs thereon, a display for displaying information to a user, and an input device for receiving input from the user, the processor being arranged to execute the programming instructions so as to be arranged to:
   prompt the user through the display with a queue of the qualifying questions;
   receive user responses from the user through the input device in response to the qualifying questions;
   use the user responses to assess for each program if all of the qualifying criteria for the program has been met; and
   communicate to the user that the applicant has qualified for one of the programs if all of the qualifying criteria for that program has been met;
   the user response to at least one of the qualifying questions being used by the processor in assessing the qualifying criteria associated with more than one program.

According to a second aspect of the present invention there is provided a method of assessing qualification of an applicant for a plurality of government immigration programs each having respective qualifying criteria associated therewith, the method comprising:
providing a computer apparatus comprising a memory storing programming instructions thereon and storing one or more qualifying questions associated with each of the qualifying criteria of the programs thereon, a processor arranged to execute the programming instructions, a display for displaying information to a user, and an input device for receiving input from the user;
prompting the user, using the computer apparatus, with a queue of the qualifying questions;
receiving user responses, using the computer apparatus, in response to the qualifying questions;
using the user responses to assess for each program, using the computer apparatus, if all of the qualifying criteria for the program has been met; and
communicating to the user, using the computer apparatus, that the applicant has qualified for one of the programs if all of the qualifying criteria for that program has been met;
when using the user responses to assess for each program, using the user response to at least one of the qualifying questions in assessing the qualifying criteria associated with more than one program.

According to a further aspect of the present invention there is provided a non-transitory computer readable medium containing programming instructions for assessing qualification of an applicant for a plurality of government immigration programs each having respective qualifying criteria associated therewith, the programming instructions being executable by a computer apparatus having a processor, a display, and an input device so as to be arranged to:
prompt the user through the display with a queue of the qualifying questions;
receive user responses from the user through the input device in response to the qualifying questions;
use the user responses to assess for each program if all of the qualifying criteria for the program has been met, including using the user response to at least one of the qualifying questions in assessing the qualifying criteria associated with more than one program; and
communicate to the user that the applicant has qualified for one of the programs if all of the qualifying criteria for that program has been met.

The processor may be further arranged to execute the programming instructions so as to dynamically alter the qualifying questions in the queue yet to be prompted to the user in response to user responses received in reply to one or more previously prompted qualifying questions.

Preferably at least one of the programs includes an essential criterium that must be met in order to qualify for the program. In this instance, the processor is preferably arranged to execute the programming instructions so as to be further arranged to (i) prompt the user with an essential question associated with the essential criteria of said at least one program and (ii) remove any remaining questions from the queue of questions that relate only to that at least one program if the user response to the essential criterium is not met. The essential questions of said at least one program are preferably located in proximity to a start of the queue of qualifying questions prompted to the user.

When one or more of the programs includes qualifying scores from a prescribed external test according to a prescribed scale among the qualifying criteria, the processor may be arranged to execute the programming instructions so as to be further arranged to (i) receive test scores of an auxiliary external test according to a different scale, and (ii) convert the test scores according said different scale to the qualifying scores according to the prescribed scale in order to assess if the qualifying criteria has been met.

When used with two or more external tests arranged to produce respective test scores according to respective different scales, in which two or more of the programs include qualifying scores from respective prescribed external tests having respective prescribed scales which are different from one another among the qualifying criteria, preferably the processor is arranged to execute the programming instructions so as to be further arranged to (i) receive test scores from any one of a plurality of different external tests having different scales associated therewith, (ii) convert the test scores to intermediate scores according to an intermediate scale, and (iii) convert the intermediate scores to the qualifying scores according to the prescribed scale for each of said two or more programs. The external tests may be language tests.

When at least one of the programs includes a classification code according to an external job classification index among the qualifying criteria, the processor is preferably arranged to execute the programming instructions so as to be further arranged to (i) prompt the user for descriptive words related to previous employment among the qualifying questions, (ii) determine at least one of the classifications codes as being a relevant code based upon the descriptive words entered as the user response to the prompt; and (iii) apply the relevant code to the qualifying criteria to assess if the applicant has qualified for said at least one of the programs that includes the classification code among the qualifying criteria.

When at least one of the programs including a skill level associated with the classification code among the qualifying criteria, preferably the processor is arranged to execute the programming instructions so as to be further arranged to (i) determine the skill level of the applicant based upon the descriptive words entered as the user response to the prompt; and (ii) apply determined skill level to the qualifying criteria.

The processor may be further arranged to execute the programming instructions so as to be further arranged to (i) determine a plurality of the classifications codes as being relevant codes based upon the descriptive words entered as the user response to the prompt; and (ii) apply each relevant code to the qualifying criteria to assess if the applicant has qualified for said at least one of the programs that includes the classification code among the qualifying criteria.

When one or more of the programs includes an education score according to a respective education scale among the qualifying criteria, and the qualifying questions include prompts requesting education information from the user, the processor is preferably arranged to execute the programming instructions so as to be further arranged to (i) receive the education information among the user responses, (ii) convert the education information to the education score, and (iii) apply the converted education score to the qualifying criteria to assess if the applicant has qualified for said one or more of the programs that includes the education score among the qualifying criteria. Preferably the education information includes a region of training or study, a date of completion, and a type of training or study.

The processor may be further arranged to execute the programming instructions so as to be further arranged to (i) identify non-qualifying programs among the programs in response to the qualifying criteria associated therewith not being met, (ii) determine if user responses that resulted in qualifying criteria not being met are correctable user responses; and (iii) communicate any correctable responses to the user to prompt the user how to subsequently qualify for the program.

When one or more of the programs includes primary criteria relating to a primary person and spousal criteria relating to a spouse of the primary person among the qualifying criteria, the processor may be arranged to execute the programming instructions so as to be further arranged to (i) prompt the user with the queue of the qualifying questions to receive user responses relating to the applicant and user responses relating to a spouse of the application, (ii) for each one or more of the programs that includes primary and spousal criteria, assess if the qualifying criteria for the program has been met using both (a) the applicant user responses applied to the primary criteria and the spouse user responses applied to the spousal criteria, and (b) the spouse user responses applied to the primary criteria and the applicant user responses applied to the spousal criteria.

When the programs are associated with one or more program categories, the processor may be arranged to execute the programming instructions so as to be further arranged to (i) prompt the user with one or more category questions; (ii) identify one or more programs within determined categories of interest based on the user responses to the one or more category questions; (iii) generate the queue of the qualifying questions according to the qualify criteria associated with the one or more programs identified within the determined categories of interest.

### BRIEF DESCRIPTION OF THE DRAWINGS

One embodiment of the invention will now be described in conjunction with the accompanying drawings in which:

FIG. 1 is a schematic representation of the immigration program qualification assessment system according to the present invention;

FIG. 2 is an example of the conversion of descriptive language relating to work experience from user responses into job classification codes and skill levels according to the job skills module;

FIG. 3 is an example of the conversion of descriptive language relating to a job offer into job classification codes and skill levels;

FIG. 4 is an example of the conversion of test scores from an external language test, to intermediate scores of the system, and finally to prescribed scores in a format required as input for one of the programs being assessed for qualification, according to the language module;

FIG. 5 is another example of the conversion of test scores from an initial scale of the external test to scores according to a prescribed scale comparable against qualifying criteria of one or more of the programs according to the language module;

FIG. 6 is an example of the conversion of education information received from user responses into standardized methodology describing education comparable against qualifying criteria of one or more of the programs according to the education module;

FIGS. 7 and 8 are exemplary screenshots output by the system; and

FIG. 9 is a flow chart representing the typical steps performed by the system as a user navigates through the prompts and enters appropriate user responses at various steps throughout the process.

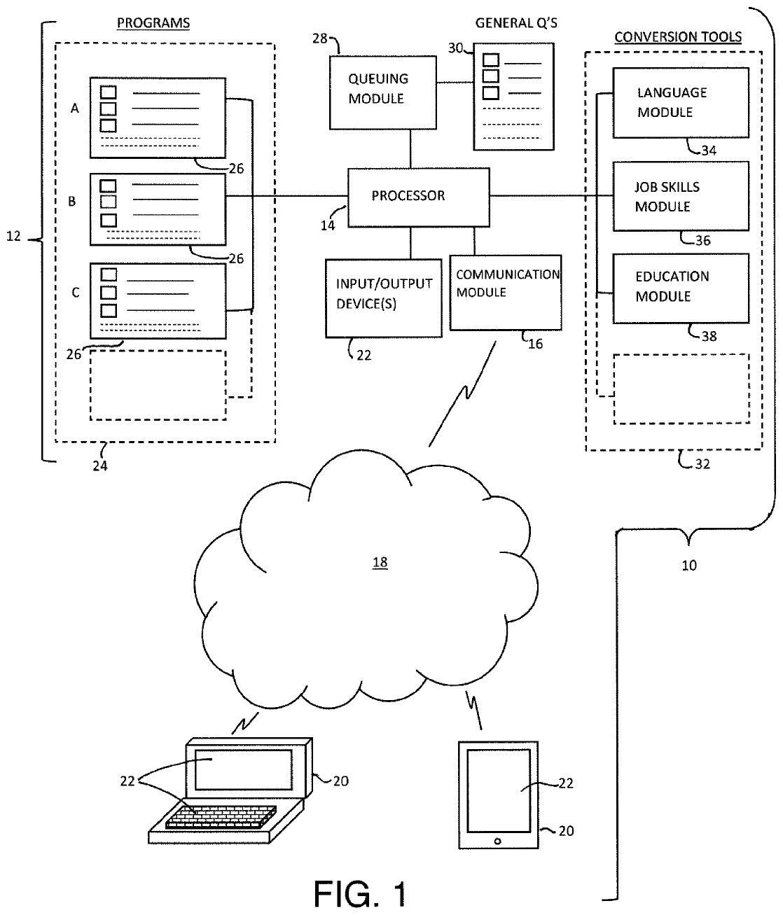

In the drawings like characters of reference indicate corresponding parts in the different figures.

### DETAILED DESCRIPTION

Referring to the accompanying figures, there is illustrated an immigration program qualification assessment system generally indicated by reference numeral 10. The system 10 is used for assessing if an applicant meets the qualifying criteria for any one of a plurality of government immigration programs.

The system 10 is intended to operate on a computer apparatus of the type including one or more processors and one or more memory devices storing programming instructions thereon which are arranged to be executed by the one or more processors to perform the various functions described herein.

In the illustrated embodiment, the computer apparatus comprises a central server 12 comprised of a central processor 14 with a communication module 16 such as a network adapter to enable the central server 12 to communicate over a network 18, for example the Internet, to a plurality of personal computer devices 20 to be used by individual users respectively. The personal computer devices 20 may be in the form of a portable laptop computer, a desktop computer, a tablet, or smart phone for example. In each instance the personal computer device comprises an internal processor and a memory storing programming instructions thereon executable by the processor to perform the various functions described herein.

The computer apparatus, including the central server 12 and one or more personal computer devices 20, includes various input and output devices 22 in the form of (i) display monitors at the server or part of the personal computer device for displaying information to users, and (ii) keyboards, touchscreens, computer mice, and the like at the server or personal computer device for receiving input from users such as user responses to various prompts as described in the following.

The programming instructions for executing the various functions may reside primarily at the server according to the preferred embodiment, or may reside in part on the personal computer device of the user. The server itself may comprise a single computer device, or a distributed network of various devices includes various processors and memory devices in communication with one another. In the preferred embodiment, the personal computer devices 20 function only as a user interface for interacting with the programming instructions which are processed primarily at the processor of the server.

The programming instructions include a program database 24 in which details of the various immigration programs 26 are stored. Each program 26 includes qualifying criteria associated therewith and a plurality of qualifying questions associated with the qualifying criteria respectively to prompt a user for required information to assess if the criteria is met. The rules for any scoring systems relating to the criteria to assess qualification or non-qualification to the program is also stored.

The programming instructions further include a queuing module 28 which is arranged to generate a queue of qualifying questions to be presented to a user through the personal computer device 20 of the user. The queue of questions includes some preliminary questions from a general bank of questions 30 as well as relevant qualifying questions acquired from any programs that are considered relevant to the applicant. The relevance of a program to an applicant may be determined by collecting responses to some initial qualifying questions presented near the start of the queue of qualifying questions.

Many of the qualifying questions are duplicated among the different programs. In this instance, the qualifying questions in common with multiple programs under consideration are only prompted to the user a single time, and the relevant user responses are compared to the relevant qualifying criteria of the multiple programs. In this manner, the user responses to at least some of the qualifying questions are used by the processor in assessing the qualifying criteria associated with more than one program.

Some programs and the qualifying questions associated therewith can be initially disqualified and removed from the queue by identifying some essential criterium that must be met for the program to be qualified for, followed by prompting of the user with an essential question associated with the essential criterium. If the essential criterium is not met, the queueing module 28 can remove any remaining questions from the queue of questions that relate only to the program that is deemed to be not qualified for. Such essential questions are typically located within the queue in proximity to the start of the queue, for example immediately following questions from the general bank of questions 30 so as to efficiently remove non-relevant questions from the queue. In this manner the programming instructions executed by the processor are arranged to dynamically alter the qualifying questions in the queue that have yet to be prompted to the user in response to the user responses received in reply to one or more of the previously prompted qualifying questions.

The system further includes a conversion tool database 32 comprising a plurality of conversion tools for converting user responses received from a user through the personal computer device of the user into the required format required by one or more programs for suitable comparison to the relevant qualifying criteria. For example, the conversion tool database may include a language conversion module 34, a job skills conversion module 36, and an education conversion module 38.

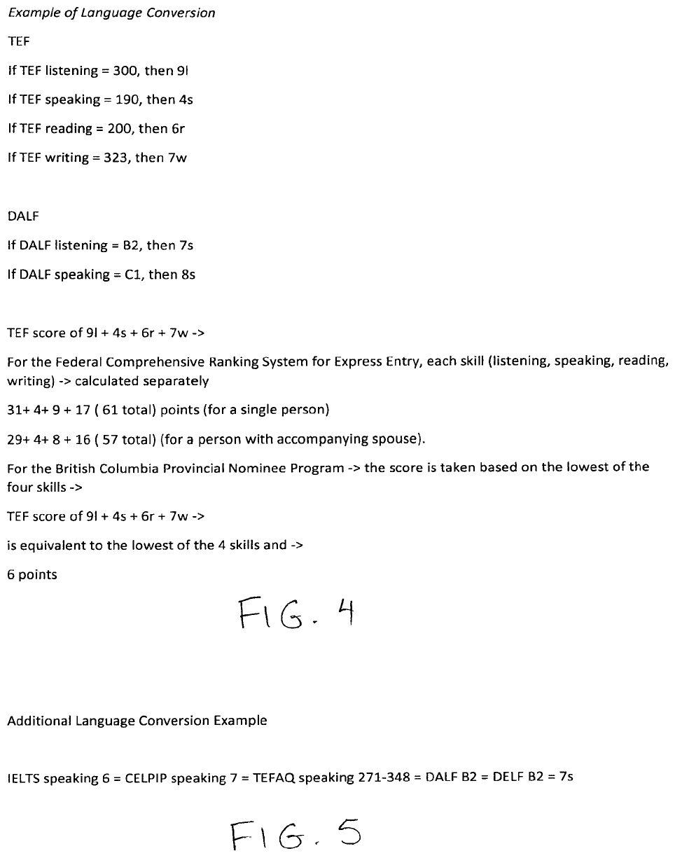

The language module 34 is arranged to receive test scores according to different testing scales of a plurality of different external language tests, convert the test scores to intermediate scores according to a common or standardized internal scale of the system, and finally convert the intermediate scores to prescribed scores required by one or more of the different programs for evaluation purposes against the relevant criteria of that program, as represented in FIGS. 4 and 5 for example.

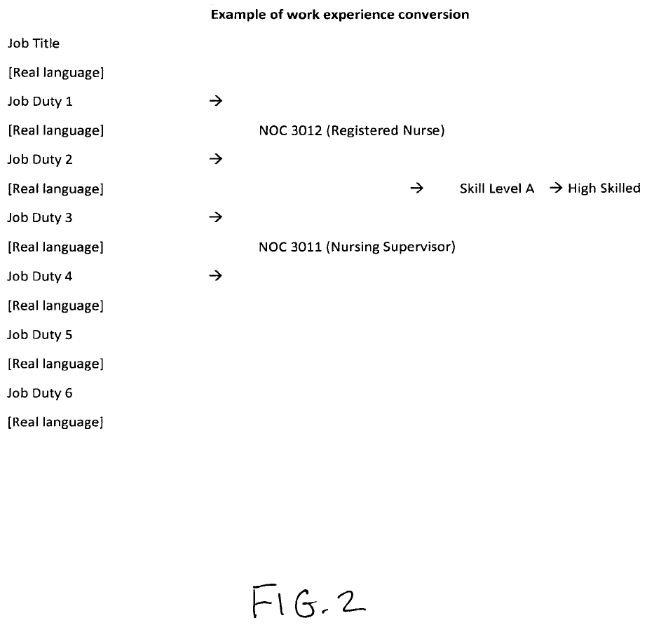

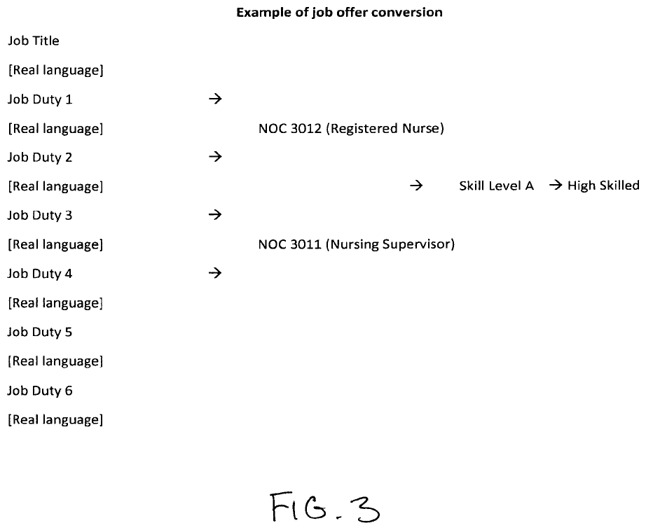

The job skills module 36 comprises a mapping between descriptive keywords and the classification codes and skill levels within a prescribed classification index as represented in FIGS. 2 and 3 for example. In this instance, the job skills module is arranged to receive descriptive language as user responses to prompts and convert the descriptive language into the relevant job code or skill level within the job codes using the mapping of the job skills module.

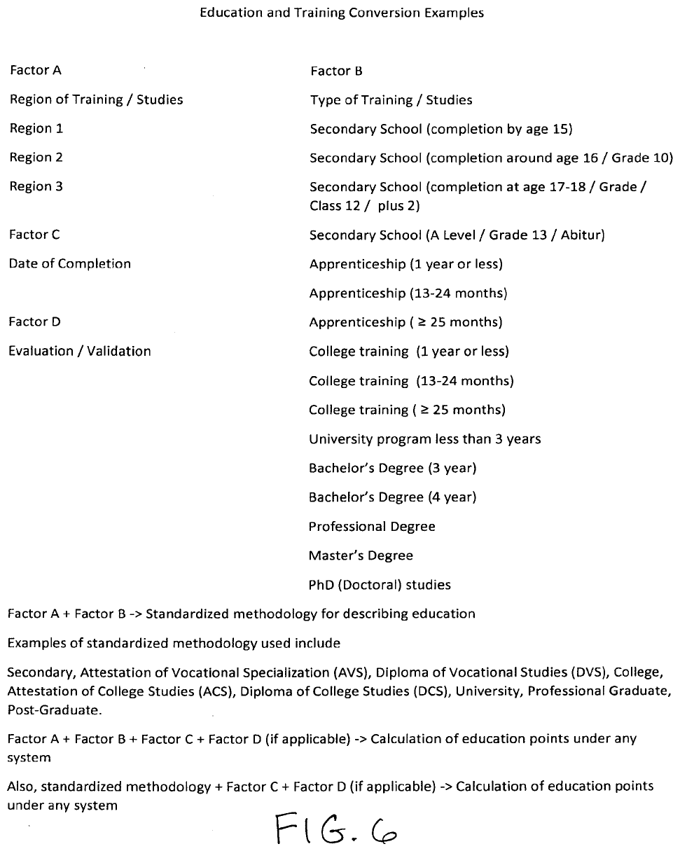

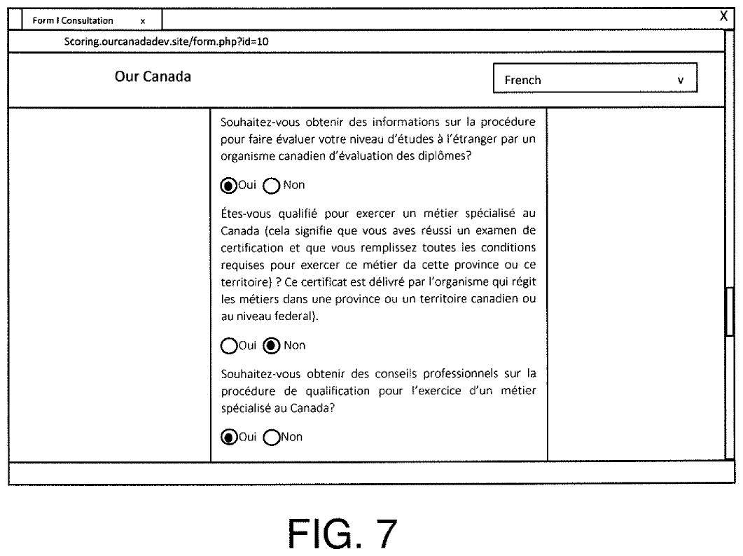

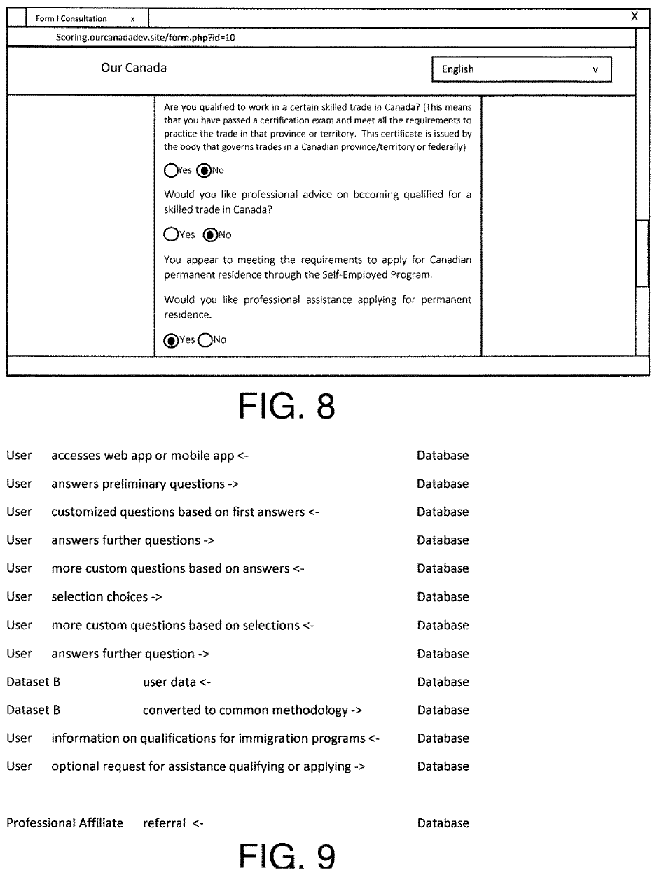

The education module 38 is arranged to collect various education information through user responses to prompts including (i) regions where training or studies have taken place, (ii) the type or category of training or study which was accomplished, (iii) the date of completion of the training or studies, and (iv) any evaluation or validation information relating to the training or studies. The education module 38 converts the received education information into standardized methodology for describing education that is recognized by the various programs stored within the program database as represented in FIG. 6 for example.

The general flow of the system and method of use of the system is shown in FIG. 9. Users initially access the tool through their personal computer or phone or tablet (it is enabled as both a web app and a mobile app for example for Android and Apple devices). The program is stored in a database (such as on cloud AWS servers). Users use their personal computer or device to access the program. The dynamic program is sent to them from the database. The user answers preliminary questions and the answers are sent to the database. The database customizes the questions based on the user's answers (so there is repeated and customized/interactive communication from the devise to the database and back, essentially question by question). Initially, the data the user inputs is also stored on their device in local storage on the device. Upon submission (there is a consent tick box and submit button) the user's data is transmitted to the server for long-term (secure) storage. The database provides the primary and further customized questions and ultimately receives the user's data. The user's data and answers are processed by the database according to hundreds of scoring rules that have been programmed and it will send messages to the user about which programs the user appears to qualify for or could qualify for.

The database/program will then ask the user questions about whether the user wants professional assistance with those immigration program applications or preliminary qualifying activities like taking a language test to better qualify. Any requests for assistance are transmitted to the database and acted on in accordance with the program. For example, if a user asks for assistance with language testing, then a referral to a language testing centre will occur. Or if a user asks for assistance with improving language skills, then a referral to a language school will occur.

In this manner, the system is arranged to (i) identify non-qualifying programs among the programs in response to the qualifying criteria associated therewith has not been met, (ii) determine if user responses that resulted in qualifying criteria not being met are correctable user responses; and (iii) communicate any correctable responses to the user to prompt the user how to subsequently qualify for the program.

The program is a mix of static content (permanent items like the code for the welcome page) and mostly dynamic content (for all questions and scoring). Examples of the limited static content include: Welcome page content and Contact Us button. Examples of dynamic content include: all questions and all scoring rules. An administrator can change any questions and scoring rules (in the database) at any time with an admin panel. (Login and changing questions and scoring rules.)

Examples of specific information communicated through the system will now be described. General questions initially prompted to the user are first presented. For example, the date of birth entered by the user is sent to the database and is used to calculate age for programs that assign points based on age.

The program asks users for both job title and job duties for any work experience or job offer.

When the user enters a job title for work experience or a job offer, then that job title is sent to the database and the program uses that job title to determine the first possible occupation code, for example a National Occupation Classification (NOC) code, for the occupation of the job or job offer.

If at least two job duties chosen by the user are eligible job duties in one or more additional occupation code(s) for the occupation of the job or job offer, then the person is associated also with the one or more additional occupation code(s).

The program also asks the user for the location of the work experience or job offer.

The program also asks the user for the number of hours per week for the work experience or job offer. The program then assesses the work as part-time or full-time and converts part-time experience where applicable to its equivalent as a fraction of full-time.

The program also asks the user if the job offer has been approved by a government body and, if so, which one.

The database then uses that occupation code or multiple occupation codes, as well as the location and any government approvals and whether the employment was full or part-time, as further inputs for the immigration programs that assign points based on work experience and/or job offers.

The database then uses that occupation code or multiple occupation codes as a further input to determine the skill level of that job offer or experience for the immigration programs that assign points based on the skill level of the work experience and/or job offers.

The database then uses that occupation code or multiple occupation codes as a further input to exclude consideration of that experience or job offer for the immigration programs that exclude certain occupations from consideration for their immigration program.

When the user enters the language test results, the database converts them to a common methodology (described elsewhere in this document and in the drawings). The database then uses the common methodology to assign points for the user in accordance with the different immigration program scoring rules.

When the user identifies that the user or spouse has relatives in a relevant jurisdiction, questions are created to ask about their immigration status in in the place of intended immigration, and location of residence. Questions are also created to ask the exact nature of the family relationship. That information is transmitted to the database, which then uses these data points to determine if any points, and the number of points, to be assigned for family connections under various immigration programs that award points for certain eligible relatives in the country or region of intended immigration, for example Canada or in a particular province of Canada.

The program also asks the user or spouse if they have relatives that will soon have eligible status in the country of intended immigration. Questions are also created to ask the exact nature of the family relationship. That information is transmitted to the database, which then uses these data points to determine if any points, and the number of points, to be assigned for family connections under various immigration programs that award points for certain eligible relatives in the country or region of intended immigration, for example in Canada or in a particular province of Canada.

The user and spouse are asked questions about their education and trades training and based on their answers, further questions are generated and transmitted from the database to clarify the type of training, studies, length, location, subject and whether or not the foreign studies or training have been assessed for equivalency in the country of intended immigration. The data is then converted by the database into usable data for use in scoring for education and training points under the various immigration programs.

The program asks the user if the user or spouse is interested in certain specific programs, like business immigration. If so, then the database transmits additional questions relating to the option selected by the user.

If a user selects interest in permanent residence, then questions are generated, and scoring is done for all (non-business) permanent residence programs.

If a user expresses interest in business immigration, then questions are generated, and scoring is done for consideration also for all business and entrepreneur immigration programs nationally and subnationally, for example federally, provincially and territorially in Canada.

When the user or spouse identifies that work experience was done as a student or refugee claimant or self-employed, then the database asks a follow up question to determine whether the work experience and person should be excluded from consideration for those immigration programs that exclude unsuccessful refugee claimants still in the country of intended immigration or self-employed candidates or work while studying as an international student.

When the user or spouse identifies that they are bankrupt, or on social assistance, then the database will exclude them from immigration programs that they are disqualified from.

When the user or spouse indicates that they are citizens of more than one country, then the database will consider them to be eligible for any special rules applicable to citizens of any of those countries.

As described herein, the system 10 is arranged to (i) prompt the user with one or more category questions; (ii) identify one or more programs within determined categories of interest based on the user responses to the one or more category questions; and (iii) generate the queue of the qualifying questions according to the qualify criteria associated with the one or more programs identified within the determined categories of interest.

The program will then convert these standardized inputs and score them against all of the immigration programs and determine for which programs, all of the mandatory criteria and scoring rules have been met or could be met.

All of the above is also true for the spouse of the user, if applicable.

As previously mentioned, the database will also consider the mirror situation and consider eligibility for the couple if the spouse was the applicant and the user was the spouse. Messages will be sent to the user relating to any potential immigration eligibility under either scenario (with user as applicant or with spouse as applicant).

As described above, when one or more of the programs including primary criteria relating to a primary person and spousal criteria relating to a spouse of the primary person among the qualifying criteria, the system 10 will consider eligibility in two manners. More particularly, the system may (i) prompt the user with the queue of the qualifying questions to receive user responses relating to the applicant and user responses relating to a spouse of the application, (ii) for each one or more of the programs that includes primary and spousal criteria, assess if the qualifying criteria for the program has been met using both (a) the applicant user responses applied to the primary criteria and the spouse user responses applied to the spousal criteria, and (b) the spouse user responses applied to the primary criteria and the applicant user responses applied to the spousal criteria.

The program also provides interactive questions relating to maintaining permanent residence, appealing the loss of permanent residence, seeking judicial review of a decision, having detention reviewed, reviewing inadmissibility or upgrading status to citizenship.

Captcha technology is used as one layer of security to prevent or reduce bots from inputting information into the database. Machine learning will be used to monitor submissions and referrals of new users as an extra layer of security to prevent or reduce non-human or non-legitimate data submissions.

As described herein a method was invented to convert language test results (regardless of the test) into a standardized format (literally, 1r, 1s, 1w, 1l, 2r, 2s, 2w, 2l, 3r, 3s, 3w, 3l . . . ) for any official language that can then be converted into the methodology used by any jurisdiction to assess language skills for each immigration program. So regardless of the language test used (and the accepted language tests may differ by location of desired immigration), the language results are converted into the invented language scoring system, which can then be converted into the language assessment format used by each immigration program.

Work experience conversion poses its own issues. In some cases, work experience can be evaluated using specific mathematical occupation codes, for example National Occupation Classification Codes (NOCs), to include or exclude occupation codes as qualifying work experience and in other cases, exact mathematical occupation codes are irrelevant and the program only considers whether the experience is “high-skilled” or “low-skilled” or management level (occupation code level 0, professional (occupation code level A), semi-skilled (occupation level B), low-skilled (occupation level C or D) etc. So, a system was developed to convert a set of inputs (real language selections by the user about their job duties) into a system that would work for all of the different immigration program methodologies.

When the programs include among the qualifying criteria qualifying scores from a prescribed external language test according to a prescribed scale, the system 10 may be further arranged to (i) receive test scores of an auxiliary external test according to a different scale, and (ii) convert the test scores according said different scale to the qualifying scores according to the prescribed scale in order to assess if the qualifying criteria has been met.

When two or more of the programs include qualifying scores from respective prescribed external language tests having respective prescribed scales which are different from one another among the qualifying criteria, the system may be further arranged to (i) receive test scores from any one of a plurality of different external tests having different scales associated therewith, (ii) convert the test scores to intermediate scores according to an intermediate scale, and (iii) convert the intermediate scores to the qualifying scores according to the prescribed scale for each of said two or more programs.

The system also provides a method for converting work experience from any country into a standard and universal methodology for use in assessing eligibility for all temporary and permanent residence and citizenship programs. It directs and converts a person's work history into a standardized and invented methodology that creates usable values that can be converted into one or more occupation codes and therefore creates a standard and universal methodology that works for programs and systems associated with various countries of intended immigration, for example both Quebec's and the rest of Canada's immigration programs and systems when the country of intended immigration is Canada.

Specifically, the system 10 allows a user to use real language to describe their job title and job duties. The system then converts that real language into mathematical occupation codes, for example National Occupation Classification codes (NOC). Then the mathematical occupation codes are organized into skill levels and then further characterized as high skill or low skill. Then regardless of whether an immigration program relies on mathematical occupation codes or skill levels or a distinction between high skilled or low skilled work, the real language selected by users is converted into usable data for points scoring under all immigration programs.

Accordingly, when at least one of the programs includes a classification code and/or a skill level according to an external job classification index among the qualifying criteria, the system is further arranged to (i) prompt the user for descriptive words related to previous employment among the qualifying questions, (ii) determine at least one of the classifications codes as being a relevant code based upon the descriptive words entered as the user response to the prompt; (iii) determine the skill level of the applicant based upon the descriptive words entered as the user response to the prompt; and (iii) apply the relevant code and/or the determined skill level to the qualifying criteria to assess if the applicant has qualified for said at least one of the programs that includes the classification code among the qualifying criteria.

The system is further capable of determining that more than one of the classifications codes are relevant codes based upon the descriptive words entered as the user response to the prompt. In this instance, the system applies each relevant code to the qualifying criteria to assess if the applicant has qualified for said at least one of the programs that includes the classification code among the qualifying criteria.

A similar methodology has been invented job offers in the country of intended immigration, for example Canada, using similar invented rules involving real language description of the job duties for conversion into mathematical occupation codes, skill levels and simplified characterization as high skilled and low skilled, as with work experience (above).

As noted above, if the real language suggests that a person is experienced in more than one mathematical occupation code (because the experience could properly be considered as experience in more than one mathematical occupation code, then the person is considered for each mathematical occupation code. This potentially expands the programs the person could qualify for as it recognizes that a person may be experienced in more than one occupation at the same time. For example, someone could be performing both nursing and nursing supervisor duties at the same time and gain experience in both occupations at the same time.

Similarly, a method was invented to convert training and education profiles (regardless of the country of origin or local method of instruction) into a standardized format that can then be converted into the methodology used to assess educational background for that immigration program. This is particularly challenging given that some regions of intended immigration have a completely different post-secondary education system than other regions of intended immigration within the same country, as is the case for Quebec compared to the rest of Canada for example.

So, the present invention transmits and converts completed secondary and post-secondary education, as well as trades training and apprenticeships, from any country into a standard methodology regardless of the destination location and education and training methodology found locally in the destination. This involved creating a new and standard methodology that takes a person's international or national education and training and converts it into an invented methodology that is universal and works for the unique education systems of the region of intended immigration, that is for both Quebec's unique education system and the rest of Canada's in the instance of Canada as the country of intended immigration.

As described herein, when one or more of the programs includes an education score according to a respective education scale among the qualifying criteria, the qualifying questions include prompts requesting education information from the user, and the system is further arranged to (i) receive the education information among the user responses, (ii) convert the education information to the education score, and (iii) apply the converted education score to the qualifying criteria to assess if the applicant has qualified for said one or more of the programs that includes the education score among the qualifying criteria. The education information may include a region of training or study, a date of completion, and a type of training or study.

The invention also uses a dynamic program so that the questions differ based on the unique circumstances of the individual and also because the immigration rules and scoring rules will frequently change and therefore the program must change each time a government rule or minimum score changes. The dynamic program facilitates regular and speedy changes to the scoring programs.

The system also includes a dynamic fields algorithm for showing sub-questions only when necessary and appropriate for a person within the system. No two people will necessarily or likely see the same questions.

Unlike the current art, this system also predicts and summarizes results and delivers them to the user. The prediction and summaries can differ weekly, monthly and if you enter the same information today and 4 months from now, the output recommendation will likely change because of subsequent changes to immigration rules and requirements. This system also predicts how changes in the user's situation would impact eligibility for the various immigration programs, for example the user completing education in two years.

Additionally, the predictions and summaries indicate to users where they are slightly short of qualifying for a given program and mention some methods that the user could use to better qualify for that program. The tool may suggest that someone do a standardized language test to qualify, or consider completing a post-secondary education program in the place of intended immigration if it would increase the user's points by a material amount.

Since various modifications can be made in my invention as herein above described, and many apparently widely different embodiments of same made, it is intended that all matter contained in the accompanying specification shall be interpreted as illustrative only and not in a limiting sense.

1. An immigration program qualification assessment system for assessing qualification of an applicant for a plurality of government immigration programs each having respective qualifying criteria associated therewith, the system comprising:
a computer apparatus comprising a processor, a memory storing programming instructions thereon and storing one or more qualifying questions associated with each of the qualifying criteria of the programs thereon, a display for displaying information to a user, and an input device for receiving input from the user, the processor being arranged to execute the programming instructions so as to be arranged to:
prompt the user through the display with a queue of the qualifying questions;
receive user responses from the user through the input device in response to the qualifying questions;
use the user responses to assess for each program if all of the qualifying criteria for the program has been met; and
communicate to the user that the applicant has qualified for one of the programs if all of the qualifying criteria for that program has been met;
the user response to at least one of the qualifying questions being used by the processor in assessing the qualifying criteria associated with more than one program.

2. The system according to claim 1 further comprising:
the processor being arranged to execute the programming instructions so as to be further arranged to dynamically alter the qualifying questions in the queue yet to be prompted to the user in response to user responses received in reply to one or more previously prompted qualifying questions.

3. The system according to claim 2 further comprising:
at least one of the programs including an essential criterium that must be met in order to qualify for the program; and
the processor being arranged to execute the programming instructions so as to be further arranged to (i) prompt the user with an essential question associated with the essential criteria of said at least one program and (ii) remove any remaining questions from the queue of questions that relate only to that at least one program if the user response to the essential criterium is not met.

4. The system according to claim 3 wherein the essential questions of said at least one program are located in proximity to a start of the queue of qualifying questions prompted to the user.

5. The system according to claim 1 further
comprising:
one or more of the programs including qualifying scores from a prescribed external test according to a prescribed scale among the qualifying criteria; and
the processor being arranged to execute the programming instructions so as to be further arranged to (i) receive test scores of an auxiliary external test according to a different scale, and (ii) convert the test scores according said different scale to the qualifying scores according to the prescribed scale in order to assess if the qualifying criteria has been met.

6. The system according to claim 1 for use with two or more external tests arranged to produce respective test scores according to respective different scales, the system further comprising:
two or more of the programs including qualifying scores from respective prescribed external tests having respective prescribed scales which are different from one another among the qualifying criteria, and
the processor being arranged to execute the programming instructions so as to be further arranged to (i) receive test scores from any one of a plurality of different external tests having different scales associated therewith, (ii) convert the test scores to intermediate scores according to an intermediate scale, and (iii) convert the intermediate scores to the qualifying scores according to the prescribed scale for each of said two or more programs.

7. The system according to claim 5 wherein the external tests are language tests.

8. The system according to claim 1 further comprising:
at least one of the programs including a classification code according to an external job classification index among the qualifying criteria; and
the processor being arranged to execute the programming instructions so as to be further arranged to (i) prompt the user for descriptive words related to previous employment among the qualifying questions, (ii) determine at least one of the classifications codes as being a relevant code based upon the descriptive words entered as the user response to the prompt; and (iii) apply the relevant code to the qualifying criteria to assess if the applicant has qualified for said at least one of the programs that includes the classification code among the qualifying criteria.

9. The system according to claim 8 further comprising:
at least one of the programs including a skill level associated with the classification code among the qualifying criteria; and
the processor being arranged to execute the programming instructions so as to be further arranged to (i) determine the skill level of the applicant based upon the descriptive words entered as the user response to the prompt; and (ii) apply determined skill level to the qualifying criteria.

10. The system according to claim 8 wherein the processor is arranged to execute the programming instructions so as to be further arranged to (i) determine a plurality of the classifications codes as being relevant codes based upon the descriptive words entered as the user response to the prompt; and (ii) apply each relevant code to the qualifying criteria to assess if the applicant has qualified for said at least one of the programs that includes the classification code among the qualifying criteria.

11. The system according to claim 1 further comprising:
one or more of the programs including an education score according to a respective education scale among the qualifying criteria;
the qualifying questions including prompts requesting education information from the user; and
the processor being arranged to execute the programming instructions so as to be further arranged to (i) receive the education information among the user responses, (ii) convert the education information to the education score, and (iii) apply the converted education score to the qualifying criteria to assess if the applicant has qualified for said one or more of the programs that includes the education score among the qualifying criteria.

12. The system according to claim 11 wherein the education information includes a region of training or study, a date of completion, and a type of training or study.

13. The system according to claim 1 wherein the processor is arranged to execute the programming instructions so as to be further arranged to (i) identify non-qualifying programs among the programs in response to the qualifying criteria associated therewith not being met, (ii) determine if user responses that resulted in qualifying criteria not being met are correctable user responses; and (iii) communicate any correctable responses to the user to prompt the user how to subsequently qualify for the program.

14. The system according to claim 1 further comprising:
one or more of the programs including primary criteria relating to a primary person and spousal criteria relating to a spouse of the primary person among the qualifying criteria;
the processor being arranged to execute the programming instructions so as to be further arranged to (i) prompt the user with the queue of the qualifying questions to receive user responses relating to the applicant and user responses relating to a spouse of the application, (ii) for each one or more of the programs that includes primary and spousal criteria, assess if the qualifying criteria for the program has been met using both (a) the applicant user responses applied to the primary criteria and the spouse user responses applied to the spousal criteria, and (b) the spouse user responses applied to the primary criteria and the applicant user responses applied to the spousal criteria.

15. The system according to claim 1 further comprising:
the programs each being associated with one or more program categories; and
the processor being arranged to execute the programming instructions so as to be further arranged to (i) prompt the user with one or more category questions; (ii) identify one or more programs within determined categories of interest based on the user responses to the one or more category questions; (iii) generate the queue of the qualifying questions according to the qualify criteria associated with the one or more programs identified within the determined categories of interest.

16. A method of assessing qualification of an applicant for a plurality of government immigration programs each having respective qualifying criteria associated therewith, the method comprising:
providing a computer apparatus comprising a memory storing programming instructions thereon and storing one or more qualifying questions associated with each of the qualifying criteria of the programs thereon, a processor arranged to execute the programming instructions, a display for displaying information to a user, and an input device for receiving input from the user;
prompting the user, using the computer apparatus, with a queue of the qualifying questions;
receiving user responses, using the computer apparatus, in response to the qualifying questions;
using the user responses to assess for each program, using the computer apparatus, if all of the qualifying criteria for the program has been met; and
communicating to the user, using the computer apparatus, that the applicant has qualified for one of the programs if all of the qualifying criteria for that program has been met;
when using the user responses to assess for each program, using the user response to at least one of the qualifying questions in assessing the qualifying criteria associated with more than one program.

17. A non-transitory computer readable medium containing programming instructions for assessing qualification of an applicant for a plurality of government immigration programs each having respective qualifying criteria associated therewith, the programming instructions being executable by a computer apparatus having a processor, a display, and an input device so as to be arranged to:
prompt the user through the display with a queue of the qualifying questions;
receive user responses from the user through the input device in response to the qualifying questions;
use the user responses to assess for each program if all of the qualifying criteria for the program has been met, including using the user response to at least one of the qualifying questions in assessing the qualifying criteria associated with more than one program; and
communicate to the user that the applicant has qualified for one of the programs if all of the qualifying criteria for that program has been met.
